(19) United States
(12) Patent Application Publication
(10) Pub. No.: US 2023/0329956 A1
(43) Pub. Date: Oct. 19, 2023

(54) DISPLAY ASSEMBLY AND WALKING ASSISTING APPARATUS INCLUDING THE SAME

(71) Applicants: Hyundai Motor Company, Seoul (KR); Kia Corporation, Seoul (KR)

(72) Inventors: Kyu Jung Kim, Seoul (KR); Hyun Seop Lim, Anyang-si (KR); Seok Young Youn, Seoul (KR); Ju Young Yoon, Suwon-si (KR); Beom Su Kim, Yongin-si (KR); Hyeon Jeong An, Seongnam-si (KR); Dong Jin Hyun, Suwon-si (KR); Sang In Park, Suwon-si (KR)

(21) Appl. No.: 17/969,063

(22) Filed: Oct. 19, 2022

(30) Foreign Application Priority Data
Apr. 19, 2022 (KR) 10-2022-0048375

(51) Int. Cl. A61H 3/00; B25J 9/00; B25J 13/06

(52) U.S. Cl. CPC A61H 3/008; B25J 9/0006; B25J 13/06; B25J 9/0009; A61H 2201/0192; A61H 2201/1215; A61H 2201/1436; A61H 2201/1472; A61H 2201/1642; A61H 2201/165; A61H 2201/1676

(57) ABSTRACT

Disclosed are a display assembly and a walking assistance apparatus including the same. The display assembly includes a body, a rotary part coupled to the body to be rotatable about a first axis extending upwards, a display part coupled to an upper side of the rotary part, and a pressing part coupled to a side surface of the body, and that allows the constrained rotary part to be rotated in a first direction as the pressing part is pressed toward the rotary part.

### CROSS-REFERENCE TO RELATED APPLICATION

This application claims the benefit of priority to Korean Patent Application No. 10-2022-0048375, filed in the Korean Intellectual Property Office on Apr. 19, 2022, the entire contents of which are incorporated herein by reference.

### TECHNICAL FIELD

The present disclosure relates to a display assembly and a walking assistance apparatus including the same.

### BACKGROUND

A conventional walking assistance apparatus may have a shape, in which a display structure for manipulating the walking assisting apparatus is located on a back of a user. As an example, a conventional walking assistance apparatus may have a structure, in which a display structure has a shape such as a bag to be mounted on a back of the user. According to conventional walking assisting apparatuses, a display is located on a back of the user such that a therapist may access the display, and a patient who wears the walking assisting apparatus may not identify the contents of the display.

Furthermore, according to the structure, in which the display structure is located on the back of the user, because the center of weight thereof is moved rearwards due to a battery connected to the display and the like when the user wears the walking assisting apparatus, the user may fall down toward the relatively dangerous back when a fall accident occurs.

### SUMMARY

The following summary presents a simplified summary of certain features. The summary is not an extensive overview and is not intended to identify key or critical elements.

Aspects of the present disclosure may relate to an apparatus that may comprise a body. The apparatus may further comprise a rotary part coupled to the body to be rotatable around an upwardly extending first axis. Further, the apparatus may comprise a display coupled to an upper side of the rotary part. The apparatus may, additionally, comprise a pressing part coupled to a side surface of the body, and may be configured to, when pressed, allow rotation of the rotary part in a first direction. The rotary part may have been constrained prior to the pressing of the pressing part.

Further aspects of the present disclosure may relate to a walking assistance apparatus. The walking assistance apparatus may comprise a leg mounted part configured to be mounted on a leg of a user to assist walking of the user. The walking assistance apparatus may further comprise a waist mounted part provided on an upper side of the leg mounted part and configured to be mounted on a waist of the user. Further, the walking assistance apparatus may comprise a display assembly configured to be coupled to a front side of the waist mounted part. The display assembly may comprise a body configured to be coupled to the front side of the waist mounted part. The display assembly may further comprise a rotary part coupled to the body to be rotatable. Further, the display assembly may comprise a display coupled to an upper side of the rotary part; and a pressing part coupled to a side surface of the body part and configured to, when pressed, allow rotation of the rotary part. The rotary part may have been constrained prior to the pressing of the pressing part.

These and other features and advantages are described in greater detail below.

### BRIEF DESCRIPTION OF THE DRAWINGS

Some features are shown by way of example, and not by limitation, in the accompanying drawings. In the drawings, like numerals reference similar elements.

FIG. 1 depicts an illustrative display assembly according to one or more aspects of the present disclosure;

FIG. 2 depicts an illustrative walking assistance apparatus including a display assembly according one or more aspects of the present disclosure;

FIG. 3 depicts an illustrative state, in which a rotary part of a display assembly may be rotated, according to one or more aspects of the present disclosure;

FIG. 4 depicts an illustrative structure of a body part for rotating a rotary part;

FIG. 5 depicts an illustrative state, in which a cam member in FIG. 4 is pressed in a second direction to be rotated in a first direction;

FIG. 6 depicts an illustrative insertion recess and a through member;

FIG. 7 depicts an illustrative state, in which a body part is cut in a cross-section that is perpendicular to forward/rearward directions;

FIG. 8 depicts an illustrative cross-sectional view of an illustrative part, in which a pressing part and a stopping part are located;

FIG. 9 depicts an illustrative state, in which a stopping member in FIG. 8 is extracted from a stopping recess; and

FIG. 10 depicts an illustrative state, in which a rotary part in FIG. 9 is rotated.

### DETAILED DESCRIPTION

Hereinafter, some aspects of the present disclosure will be described in detail with reference to the exemplary drawings. In providing reference numerals to the constituent elements of the drawings, the same elements may have the same reference numerals even if they are displayed on different drawings.

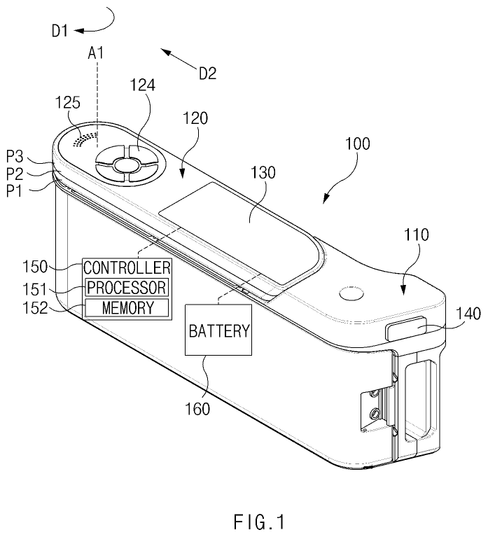

A display assembly 100, according to one or more aspects of the present disclosure, may define the display assembly 100 that may be mounted on a walking assisting apparatus 200. FIG. 1 depicts an illustrative display assembly 100 according to one or more aspects of the present disclosure. For convenience of description, the walking assistance apparatus 200, on which the display assembly 100 may be mounted, will be described in detail.

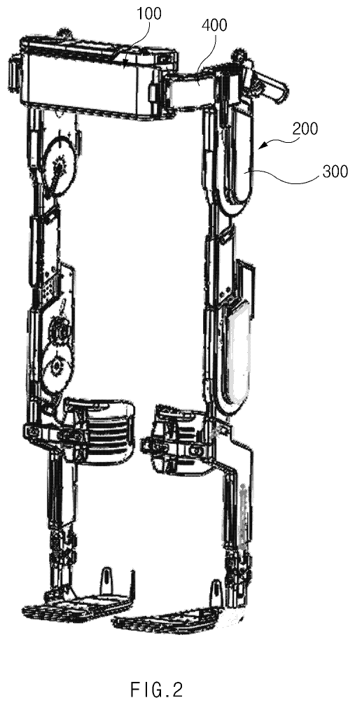

The walking assistance apparatus 200 according to one or more aspects of the present disclosure may be defined as a waking assistance apparatus that may be mounted on a body of a user to assist walking of the user. FIG. 2 depicts an illustrative walking assistance apparatus 200 including the display assembly 100 according to one or more aspects of the present disclosure.

As illustrated in FIG. 2, the walking assistance apparatus 200, according to one or more aspects of the present disclosure, may include a leg mounted part 300 and a waist mounted part 400. The leg mounted part 300 may be configured to be mounted on a leg of the user to assist walking of the user. The waist mounted part 400 may be provided on an upper side of the leg mounted part 300 and may be configured to be mounted on the waist of the user.

A device for operating the walking assistance apparatus 200 may be necessary to operate the walking assistance apparatus 200. The display assembly 100, according to one or more aspects of the present disclosure, may be mounted on the walking assistance apparatus 200 to assist the operation of the walking assistance apparatus 200. Referring to FIG. 1, According to aspects, the display assembly 100 may include a display part 130 that may display contents to the user to assist the operation of the walking assistance apparatus 200. Additionally or alternatively, the display assembly 100 may include a button member 124 to assist in the operation of the walking assistance apparatus 200. The display assembly 100 may include a speaker member 125 for delivering sounds to the user regarding an operation of the walking assistance apparatus 200. According to aspects, as illustrated in FIG. 1, the display part 130, the button member 124, and the speaker member 125 may be provided on an upper surface of the display assembly 100.

The display assembly 100 may be mounted on a front side of the walking assistance apparatus 200. As the display assembly 100 is mounted on the front side of the walking assistance apparatus 200, the user may manipulate the display part 130 while easily viewing the display part 130.

Referring to FIG. 2, according to the present disclosure, the display assembly 100 may be coupled to the front side of the walking assistance apparatus 200 so that the user may directly manipulate the walking assistance apparatus 200. Additionally, the location of the display assembly 100 on the front side may, advantageously, place the weight of the display assembly 100 on the front side as opposed to the rear side. Accordingly, danger of a rear side fall accident of a user of the walking assistance apparatus 200 may be reduced.

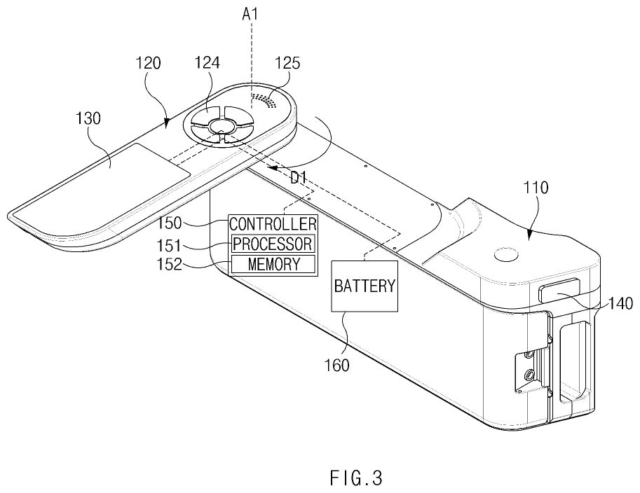

FIG. 3 depicts an illustrative state, in which a rotary part of a display assembly may be rotated, according to one or more aspects of the present disclosure. According to aspects of the present disclosure, the display assembly 100 may include a body part 110, a rotary part 120, the display part 130, and a pressing part 140. The body part 110 may be mounted on the front side of the walking assistance apparatus 200. A battery 160 may be disposed in the body part 110. The battery 160 may be configured to supply electric power to operate the display part 130. Furthermore, a controller 150, which will be described below, may be disposed in the body part 110.

The rotary part 120 may be coupled to the body part 110 to be rotatable about a first axis A1 that extends in the upward and downward directions. The display part 130 may be coupled to an upper side of the rotary part 120. The display part 130, as described above, may display contents regarding the operation of the walking assistance apparatus 200. According to aspects contents displayed by the display part 130 may be related to contents transmitted by a device electrically connected thereto. As an example, the display part 130 may be connected to an image transmitting device. Accordingly, an image may be displayed on the display part 130 from the image transmitting device.

The pressing part 140 may be coupled to a side surface of the body part 110. The rotation of the rotary part 120 may be constrained. The pressing part 140 may be configured to allow the rotation of the rotary part 120, which was constrained, to be rotated in a first direction D1 as the pressing part 140 is pressed toward the rotary part 120.

According to occasions, the user may need to rotate the display part 130 of the display assembly 100. For example, the contents displayed on the display part 130 may be suitable for a landscape mode rather than a portrait mode. Accordingly, the user may desire to rotate the display part 130. As illustrated in FIG. 3, according to the present disclosure, because the display coupled to the rotary part 120 may be rotatable within a range of a specific angle, the display may be rotated according to a desire of the user, and thus visibility and a convenience of the operation of the walking assistance apparatus 200 may be increased.

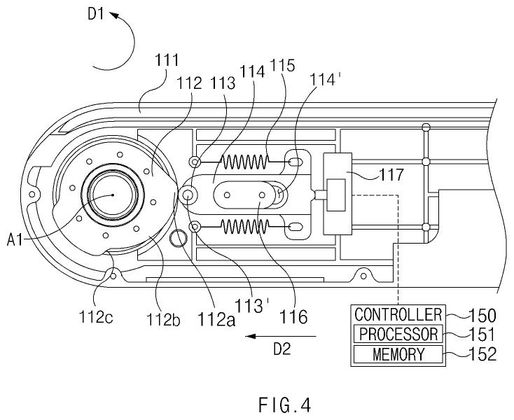

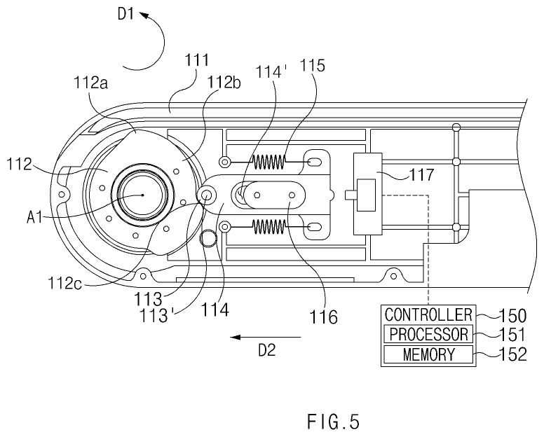

FIG. 4 depicts an illustrative structure of the body part 110 for rotating the rotary part 120. As illustrated in FIG. 4, the body part 110 may include a body member 111, a cam member 112, a bearing member 113, and a sliding member 114. It may be understood that FIG. 4 is a view obtained by cutting the display assembly 100 along a plane that is perpendicular to the upward/downward directions at a first location P1 of FIG. 1. FIG. 5 depicts an illustrative state, in which the cam member in FIG. 4 is pressed in a second direction to be rotated in the first direction. It may be understood that the rotation of the cam member 112 in the first direction corresponds to rotation of the rotary part 120 in the first direction D1 as will be described below.

The cam member 112 may be coupled to the body member 111 to be rotatable about the first axis A1. Furthermore, the cam member 112 may be fixedly coupled to the rotary part 120. This may mean that the rotary part 120 may be rotated in conjunction with the rotation of the cam member 112. The cam member 112 may have a shape, of which a distance between an outer surface thereof and the first axis A1 varies along a circumferential direction on a plane that is perpendicular to the first axis A1.

The bearing member 113 may be configured to contact the cam member 112, and may be rotated in conjunction with the rotation of the cam member 112. As an example, the bearing member 113 may be configured to contact the cam member 112, and may be rotated in an opposite direction to a rotational direction of the cam member 112. The rotation then may be a rotation about a reference axis.

The bearing member 113 may be coupled to a side of the sliding member 114. The sliding member 114 may move in leftward/rightward directions which may be a direction in which the sliding member 114 may become farther from, or closer to, the axis A1. The sliding member 114 may be moved in the leftward/rightward directions.

A first guide hole 114′ may be formed in the sliding member 114. The first guide hole 114′ may have a slot shape that extends along the leftward/rightward directions. The body part 110 may further include a first guide member 116. The first guide member 116 may be configured to be inserted into the first guide hole 114′ and may be configured to guide movement of the sliding member 114 in the leftward/rightward directions.

A state, in which the rotary part 120 is constrained with respect to the body part 110, may be referred to as a first state, and a state, in which the rotary part 120, from the first state, is rotated along the first direction D1, may be referred to as a second state. FIG. 1 may be understood as illustrating the first state. FIG. 3 may be understood as illustrating the second state.

Referring to FIG. 4, the cam member 112 may include a first part 112a and a second part 112b. The first part 112a may be a part of the cam member 112, which may contact the bearing member 113 in the first state. The second part 112b may be a part of the cam member 112, which may contact the bearing member 113 in the second state. A spacing distance from the first part 112a to the first axis A1 may be larger than a spacing distance from the second part 112b to the first axis A1. Furthermore, the cam member 112 may have a shape, in which a spacing distance from an area, in which the bearing member 113 and the cam member 112 contact each other, to the first axis A1 decreases as the cam member 112 rotates from the first state to the second state.

The cam member 112 may include a third part 112c. The third part 112c may contact the bearing member 113 in a third state. The third state may refer to a state, in which the rotary part 120 in the first state is maximally rotated along the first direction D1.

A spacing distance from the third part 112c to the first axis A1 may be larger than the spacing distance from the second part 112b to the first axis A1. As an example, the third part 112c may have a stepped shape at a part in which it meets the second part 112b. When the bearing member 113 is stopped by the third part 112c having the stepped shape, the rotation of the cam member 112 in the first direction D1 may be stopped. This may mean that rotation of the cam member 112 in the first direction D1 may be constrained in a range of a specific angle by the third part 112c.

As described above, the rotation of the cam member 112 may be constrained in the range of the specific angle due to the shape of the cam member 112. Hereinafter, an additional structure for assisting the constraint of the rotation of the cam member 112 within the range of the specific angle will be described in detail.

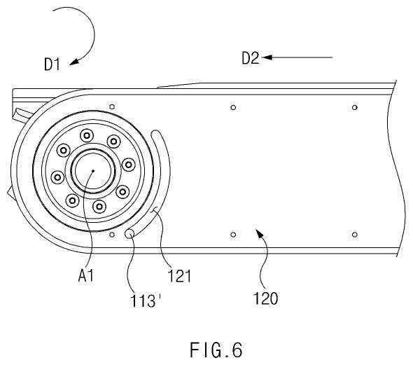

FIG. 6 depicts an illustrative insertion recess 121 and a through member 113′. It may be understood that FIG. 6 is a view obtained by cutting the display assembly 100 along the plane that is perpendicular to the upward/downward directions at a second location P2 of FIG. 1.

As illustrated in FIG. 6, the body part 110 may further include the through member 113′. The through member 113′ may be configured to pass through a central portion of the bearing member 113, and may extend in the upward/downward directions. The rotary part 120 may include the insertion recess 121. The insertion recess 121 may be opened downwards such that an upper end portion of the through member 113′ is inserted thereinto, and may have an arcuate shape (e.g., of a fan). Then, an included angle of the fan shape may correspond to an angle, by which the rotary part may be rotated. The through member 113′ may be located at an end or the insertion recess 121 in the first direction D1 in the first state, and the through member 113′ may be located at an end of the insertion recess 121 in an opposite direction to the first direction D1 in the third state.

As illustrated in FIG. 6, the through member 113′ may be located at an end of the insertion recess 121 in the first direction D1 in the first state. The constraint of the rotation of the cam member 112 within the range of the specific angle may be assisted through structures of the through member 113′ and the insertion recess 121.

Referring to FIG. 5, the body part 110 may further include a first elastic member 115. The first elastic member 115 may connect the body member 111 and the sliding member 114. As an example, the first elastic member may be a spring. The first elastic member may elastically pull the sliding member 114 in the second direction D2.

As an example, the sliding member 114 may have a first area that has the first guide hole 114′ and extends in the second direction D2, and a second area that extends in a direction perpendicular to the second direction D2, wherein the second area is disposed at an end of the first area in an opposite direction to the second direction D2. Then, an end of the first elastic member 115 in the second direction D2 may be connected to the body member 111, and an opposite end thereof may be connected to the second area. Furthermore, the first elastic member 115 may be a prolonged state in the first state. The first elastic member 115 in the prolonged state may elastically pull the sliding member 114 in the second direction D2, in the first state.

The bearing member 113 may be moved in the second direction D2 by the sliding member 114 as the sliding member 114 is elastically pulled in the second direction D2 by the first elastic member 115. As the bearing member 113 is moved in the second direction D2 by the sliding member 114, the bearing member 113 may press the cam member 112 in the second direction D2. The cam member 112, pressed in the second direction D2, may be rotated about the first axis A1 in the first direction D1. This may be understood that the state of FIG. 4 is transited to the state of FIG. 5. The rotary part 120 also is rotated in the first direction D1 as the cam member 112 is rotated about the first axis A1 in the first direction D1. This may be understood that the state of FIG. 1 is transited to the state of FIG. 3.

The body part 110 may further include a switch member 117. As illustrated in FIG. 4, the switch member 117 may contact the sliding member 114 in the first state. Furthermore, as illustrated in FIG. 5, the switch member 117 may be spaced apart from the sliding member 114 in the second state. The switch member 117 may be electrically connected to the controller 150.

The controller 150 may be electrically connected to the display part 130. The controller 150 may be configured to control the display part 130 to change the contents transmitted to the display part 130 based on whether the switch member 117 and the sliding member 114 contact each other. As an example, when the switch member 117 and the sliding member 114 contact each other, the contents transmitted to the display part 130 may be transmitted in a landscape mode state, and when the switch member 117 and the sliding member 114 are spaced apart from each other, the contents transmitted to the display part 130 may be transmitted in a portrait mode state.

The controller 150 may include a processor 151 and a memory 152. The processor 151 may include a microprocessor such as a field Programmable gate array (FPGA), an application specific integrated circuit (ASIC), a central processing unit (CPU). The memory 152 may store instructions that may be bases for generating commands for an operation of the walking assistance apparatus 200 by the processor 151. The memory 152 may be a data storage such as a hard disk drive (HDD), a solid state drive (SSD), a volatile medium, and/or a nonvolatile medium.

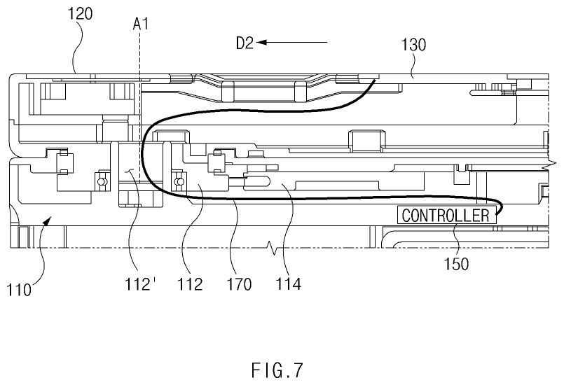

FIG. 7 depicts an illustrative state, in which a body part is cut in a cross-section that is perpendicular to forward/rearward directions. The forward/rearward directions may be directions that are perpendicular to the upward/downward directions and the leftward/rightward directions. Referring to FIG. 7, the display part 130 and the controller 150 may be electrically connected to each other by a wiring part 170. As illustrated in FIG. 7, the wiring part 170 may pass through an opening 112′ that may pass through a central portion of the cam member 112 upwards and downwards to electrically connect the display part 130 and the controller 150.

According to the above description, it may be seen that a force, by which the rotary part 120 tends to be rotated in the first direction D1, is applied to the rotary part 120 by the first elastic member 115, but the rotation of the rotary part 120 in the first direction D1 is constrained before the pressing part 140 is pressed. Thereafter, the constraint of the rotary part 120 may be released through the pressing of the pressing part 140 whereby the rotary part 120 is rotated.

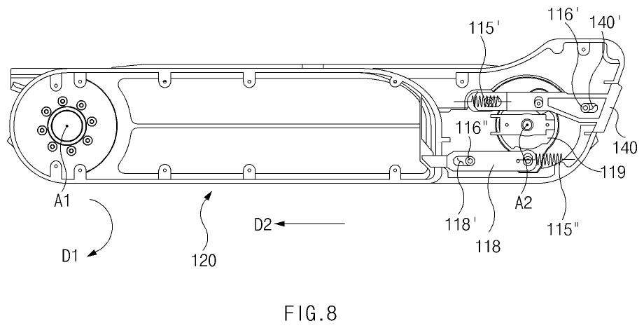

FIG. 8 depicts an illustrative cross-sectional view of an illustrative part, in which the pressing part 140 and a stopping member 118 are located. For reference, it may be understood that FIG. 8 is a view that may be obtained by cutting the display assembly 100 along a plane that is perpendicular to the upward/downward directions at a third location P3 of FIG. 1.

The body part 110 may include the stopping member 118. The stopping member 118 may be connected to the pressing part 140. The connection here may not refer to direct connection, but may be a concept including indirect connection, through which the stopping member 118 is connected to the pressing part 140.

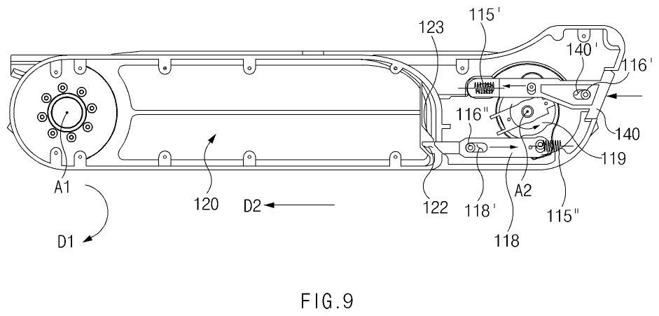

The stopping member 118 may be configured to be moved in an opposite direction to a movement direction of the pressing part 140. A stopping recess 122 (see FIG. 9) may be formed in the rotary part 120. The stopping recess 122 may be a recess, into which the stopping member 118 in the first state is inserted. As the stopping member 118 is inserted into the stopping recess 122, rotation of the rotary part 120 in the first direction D1 may be constrained.

FIG. 9 depicts an illustrative state, in which the stopping member 118 in FIG. 8 is extracted from the stopping recess 122. As illustrated in FIG. 9, when the pressing part 140 is pressed toward the second direction D2, the stopping member 118 may be moved in an opposite direction to the second direction D2 to deviate from the stopping recess 122.

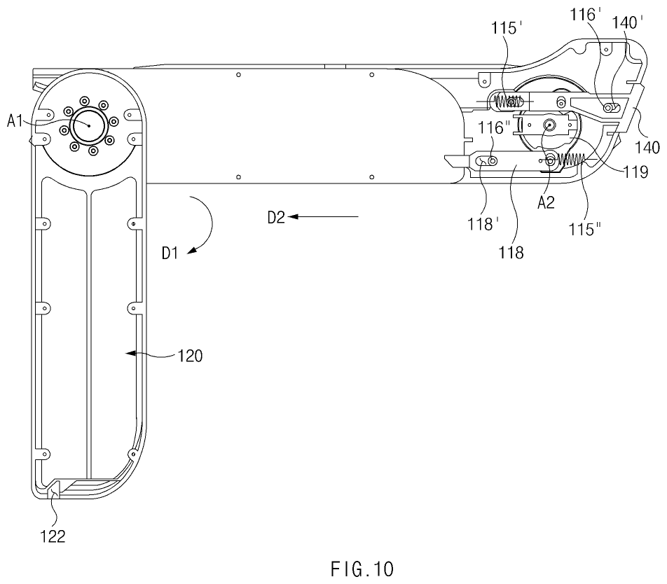

FIG. 10 depicts an illustrative state, in which the rotary part 120 in FIG. 9 is rotated. As illustrated in FIG. 10, when the stopping member 118 deviates from the stopping recess 122, the constraint of the rotary part 120 is released and the rotary part 120 is rotated in the first direction D1.

Referring to FIG. 8, the body part 110 may further include a rotary member 119. The rotary member 119 may be configured to be rotated about a second axis A2 that extends upwards/downwards, and may be connected to the pressing part 140 and the stopping member 118. The second axis A2 may be disposed between the pressing part 140 and the stopping member 118. Through the structure, when the pressing part 140 is moved in the second direction D2, the stopping member 118 may be moved in an opposite direction to the second direction D2.

The body part 110 may further include a second elastic member 115′. As an example, the second elastic member 115′ may be a spring. The second elastic member 115′ may press the pressing part 140 in the opposite direction to the second direction D2. To achieve this, an end of the second elastic member 115′ in the second direction D2 may be coupled to the body member 111, and an end of the second elastic member 115′ in an opposite direction thereto may be coupled to the pressing part 140.

If the pressing part 140 is pressed by the user, the second elastic member 115′ may be contracted. If the pressing of the pressing part 140 by the user is finished, the pressing part 140 may return to an original location due to the second elastic member 115′.

The body part 110 may further include a third elastic member 115″. As an example, the third elastic member 115″ may be a spring. The third elastic member 115″ may elastically press the stopping member 118 in the second direction D2. To achieve this, an end of the third elastic member 115″ in the second direction D2 may be coupled to the stopping member 118, and an end of the third elastic member 115″ in an opposite direction thereto may be coupled to the body member 111.

If the pressing part 140 is pressed by the user, the third elastic member 115″ may be contracted. If the pressing of the pressing part 140 by the user is finished, the stopping member 118 may return to an original location due to the third elastic member 115″. Then, if the state corresponds to the first state, the stopping member 118 may be inserted into the stopping recess 122 again.

A second guide hole 140′ may be formed in the pressing part 140. The second guide hole 140′ may have a slot shape that extends along the leftward/right directions. The body part 110 may further include a second guide member 116′. The second guide member 116′ may be inserted into the second guide hole 140′ and may guide movement of the pressing part 140 in the leftward/rightward directions. Furthermore, a guide hole that extends in a direction other than the leftward/rightward directions and a guide member may be further formed.

Further, a third guide hole 118′ may be formed in the stopping member 118. The third guide hole 118′ may have a slot shape that may extend along the leftward/right directions. The body part 110 may further include a third guide member 116″. The third guide member 116″ may be inserted into the third guide hole 118′ and may guide movement of the stopping member 118 in the leftward/rightward directions. Furthermore, a guide hole that extends in a direction other than the leftward/rightward directions and a guide member may be further formed.

Referring to FIG. 9, the rotary part 120 may further include an inclined surface member 123. The inclined surface member 123 may be located on a side of the stopping recess 122. The inclined surface member 123 may have an inclined surface to contact the stopping member 118 when the rotary part 120 returns from the second state to the first state so as to move the stopping member 118 in the opposite direction to the second direction D2. In more detail, the inclined surface member 123 may have a shape, a width of which may become smaller as it goes in the opposite direction to the second direction D2, that is, as it goes toward the pressing part 140. If the stopping member 118 is moved in the opposite direction to the second direction D2, it may be moved in the second direction D2 again by an elastic force of the third elastic member 115″ if the stopping member 118 is not in contact with the inclined surface member 123. Accordingly, the stopping member may be inserted into the stopping recess 122 located on a side of the inclined surface member 123 in the first direction D1 in the process.

Hereinafter, an operation of the display assembly 100, according to one or more aspects of the present disclosure will be described in detail based on the above-described contents. First, an operation of changing a location of the display part 130 by rotating the rotary part 120 in the first direction D1 will be described in detail. This may be understood that the first state, as in FIG. 1, is transitioned to the third state via the second state as in FIG. 3.

First, referring to FIG. 8, in the first state, the user may press the pressing part 140 toward the second direction D2. Then, if the pressing part 140 is pressed, the stopping member 118 may be extracted from the stopping recess 122.

Second, the constraint of the rotary part 120 may be released as the stopping member 118 is extracted from the stopping recess 122. Referring to FIG. 4, the bearing member 113 may press the cam member 112 in the second direction D2 due to the sliding member 114 being pulled in the second direction D2 by the first elastic member 115. Due to the shape of the cam member 112, the cam member 112 may receive a force, by which it may tend to rotate along the first direction D1.

Third, the cam member 112 may rotate along the first direction D1. It may be understood that this rotation may correspond to the second state. The rotary part 120, fixed to the cam member 112, may be rotated along the first direction D1 together with the cam member 112, and then, the contents displayed on the display part 130 my change while the sliding member 114 is spaced apart from the switch member 117.

Finally, the bearing member 113 may be stopped by the third part 112c. Furthermore, referring to FIG. 6, the through member 113′ may be stopped while contacting an end of the insertion recess 121 in the opposite direction of the first direction D1. It may be understood that the state depicted in FIG. 6 may correspond to the second state.

Hereinafter, an operation of changing a location of the display part 130 by rotating the rotary part 120 in the opposite direction to the first direction D1 may be described in detail. This may be understood that the third state is transitioned to the first state in FIG. 1 via the second state as in FIG. 3.

The user may rotate the rotary part 120 in the opposite direction to the first direction D1 by pressing the rotary part 120 in the opposite direction of the first direction D1 while gripping it. If the force applied by the user is higher than the elastic force of the first elastic member 115, the rotary part 120 may be rotated in the opposite direction to the first direction D1.

If the rotary part 120 is rotated in the opposite direction to the first direction D1, the inclined surface member 123 and the stopping member 118 may contact each other. The inclined surface member 123 may press the stopping member 118 in the opposite direction to the second direction D2, and the stopping member 118 may be moved in the opposite direction to the second direction D2 along an inclined shape of the inclined surface member 123.

Additionally, if the rotary part 120 is rotated in the opposite direction to the first direction D1, the stopping member 118 may be moved in the second direction D2 if the contact is no longer being made between the inclined surface member 123 and the stopping member 118, and the force, by which the inclined surface member 123 may press the stopping member 118 in the opposite direction to the second direction D2, may decrease. The stopping recess 122 may be located on a side of the stopping member 118 in the second direction D2, and the stopping member 118 may be inserted into the stopping recess 122. If the stopping member 118 is inserted into the stopping recess 122, rotation of the rotary part 120 in the first direction D1 may be constrained.

According to the present disclosure, the display assembly may be coupled to the front side of the walking assistance apparatus so that the user may directly manipulate the walking assistance apparatus.

Furthermore, according to the present disclosure, because the display may be rotated within a range of a specific angle, the display may be rotated according to a desire of the user, whereby visibility and a convenience of the walking assistance apparatus may be increased.

In addition, according to the present disclosure, the display assembly may be located on a front side of the walking assistance apparatus whereby a fall accident to a rear side may be prevented.

An aspect of the present disclosure provides a display assembly that is coupled to a front side of a walking assisting apparatus to allow a user to directly manipulate the walking assisting apparatus, and a walking assisting apparatus including the same.

Another aspect of the present disclosure provides a display assembly, a display of which may be rotated according to a necessity of a user, and a walking assisting apparatus including the same.

Another aspect of the present disclosure provides a display assembly that may prevent a danger of a fall accident, in which a user falls to a rear side, and a walking assisting apparatus including the same.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a display assembly includes a body part, a rotary part coupled to the body part to be rotatable about an imaginary first axis extending upwards, a display part coupled to an upper side of the rotary part, and a pressing part coupled to a side surface of the body part, and that allows the constrained rotary part to be rotated in a first direction as the pressing part is pressed toward the rotary part.

In another example, the body part may include a body member, a cam member coupled to the body member to be rotatable about the first axis, and fixedly coupled to the rotary part, a bearing member that contacts the cam member, and rotated in conjunction with rotation of the cam member, and a sliding member, to which the bearing member is coupled to be rotatable in a second direction that is any one of leftward/rightward directions that are a direction, in which the sliding member becomes farther from the cam member, and a direction, in which the sliding member becomes closer to the cam member, and being movable in the leftward/rightward directions, and the cam member may have a shape, of which a distance between an outer surface thereof and the first axis along a circumferential direction on a plane that is perpendicular to the first axis.

In another example, when a state, in which the rotary part is constrained with respect to the body part, is a first state and a state, in which the rotary part is rotated from the first state along the first direction, is a second state, the cam member may include a first part that is a part contacting the bearing member in the first state, and a second part that is a part contacting the bearing member in the second state, and a spacing distance from the first part to the first axis is larger than a spacing distance from the second part to the first axis.

In another example, when a state, in which the rotary part is maximally rotated from the first state along the first direction, is a third state, the cam member may include a third part contacting the bearing member in the third state, and of which a spacing distance to the first axis is larger than the spacing distance from the second part to the first axis.

In another example, the body part may further include a first elastic member connecting the body member and the sliding member, and the bearing member may be moved in the second direction by the sliding member as the sliding member is elastically pulled in the second direction by the first elastic member to press the cam member in the second direction.

In another example, a slotted first guide hole extending along the leftward/rightward directions may be formed in the sliding member, and the body part may further include a first guide member that is inserted into the first guide hole, and that guides movement of the sliding member in the leftward/rightward directions.

In another example, the body part may further include a switch member contacting the sliding member in the first state, and spaced apart from the sliding member in the second state, the display assembly may further include a controller electrically connected to the switch member, and the controller may be electrically connected to the display part, and controls the display part to change contents transmitted to the display part based on whether the switch member and the sliding member contact each other.

In another example, an opening may pass through a central portion of the cam member upwards and downwards, and the display assembly may further include a wiring part passing through the opening and electrically connecting the display part and the controller.

In another example, when a state, in which the rotary part is maximally rotated from the first state along the first direction, is a third state, the body part further may include a through member that passes through a central portion of the bearing member, and extending upwards and downwards, the rotary part may include an insertion recess opening downwards, into which an upper end portion of the through member is inserted, and having an arc shape of a fan, and the through member may be located at an end of the insertion recess in the first direction in the first state, and is located at an end of the insertion recess, in an opposite direction to the first direction in the third state.

In another example, the cam member may have a shape, in which a spacing distance from an area, in which the bearing member and the cam member contact each other, to the first axis decreases as the cam member goes from the first state to the second state.

In another example, the body part may include a stopping member connected to the pressing part, and that is moved in an opposite direction to a movement direction of the pressing part, when a state, in which the rotary part is constrained with respect to the body part, is a first state and a state, in which the rotary part is rotated from the first state along the first direction, is a second state, a stopping recess, into which the stopping member is inserted in the first state, may be formed in the rotary part.

In another example, when the pressing part is pressed toward a second direction that is any one of leftward/rightward directions, the stopping member may be moved in an opposite direction to the second direction to deviate from the stopping recess.

In another example, the body part may further include a rotary member that is rotatable about an imaginary second axis extending upwards, and connected to the pressing part and the stopping member, and the second axis may be disposed between the pressing part and the stopping member.

In another example, the body part may further include a second elastic member that presses the pressing part in an opposite direction to the second direction.

In another example, the body part may further include a third elastic member that presses the stopping member in the second direction.

In another example, a slotted second guide hole extending along the leftward/rightward directions may be formed in the pressing part, and the body part may further include a second guide member that is inserted into the second guide hole, and that guides movement of the pressing part in the leftward/rightward directions.

In another example, a slotted third guide hole extending along leftward/rightward directions may be formed in the stopping member, and the body part may further include a third guide member that is inserted into the third guide hole, and that guides movement of the stopping member in the leftward/rightward directions.

In another example, the rotary part may further include an inclined surface member located in a direction of the stopping recess, which is opposite to the first direction, and having an inclined surface to contact the stopping member when the inclined surface member returns from the second state to the first state so as to move the stopping member in an opposite direction to the second direction. According to another aspect of the present disclosure, a walking assisting apparatus includes a leg mounted part mounted on a leg of a user to assist waling of the user, a waist mounted part provided on an upper side of the leg mounted part and mounted on a waist of the user, and a display assembly that is coupled to a front side of the waist mounted part, and the display assembly includes a body part that is coupled to the front side of the waist mounted part, and a rotary part coupled to the body part to be rotatable, a display part coupled to an upper side of the rotary shaft, and a pressing part coupled to a side surface of the body part and that allows the rotary part constrained to be rotated as the pressing part is pressed.

The above description is a simple exemplification of the technical spirits of the present disclosure, and the present disclosure may be variously modified by those skilled in the art to which the present disclosure pertains without departing from the scope of the present disclosure. Accordingly, the aspects disclosed in the present disclosure are not provided to limit the technical spirits of the present disclosure but provided to describe the present disclosure, and the scope of the technical spirits of the present disclosure is not limited by the aspects herein. Accordingly, the technical scope of the present disclosure should be construed by the attached claims, and all the technical spirits within the equivalent ranges fall within the scope of the present disclosure.

What is claimed is:

1. An apparatus comprising:
a body;
a rotary part coupled to the body to be rotatable about an upwardly extending first axis;
a display coupled to an upper side of the rotary part; and
a pressing part coupled to a side surface of the body, and configured to, when pressed, allow rotation of the rotary part in a first direction,
wherein the rotary part was constrained prior to the pressing of the pressing part.

2. The apparatus of claim 1, wherein the body comprises:
a body member;
a cam coupled to the body member to be rotatable about the first axis, and fixedly coupled to the rotary part;
a bearing configured to contact the cam and rotate in conjunction with rotation of the cam; and
a sliding member, to which the bearing is rotatably coupled, configured to move in a second direction, in which the sliding member becomes closer to the first axis, and a third direction, in which the sliding member becomes farther from the first axis, and
wherein the cam has a shape, of which a distance between an outer surface thereof and the first axis varies along a circumferential direction on a plane that is perpendicular to the first axis.

3. The apparatus of claim 2, wherein a state, in which the rotary part is constrained with respect to the body, is defined as a first state, and a state, in which the rotary part is rotated from the first state along the first direction, is defined as a second state,
wherein the cam comprises:
a first part that contacts the bearing in the first state; and
a second part that contacts the bearing in the second state, and
wherein a spacing distance from the first part to the first axis is larger than a spacing distance from the second part to the first axis.

4. The apparatus of claim 3, wherein a state, in which the rotary part is maximally rotated from the first state along the first direction, is defined as a third state,
the cam further comprising:
a third part that contacts the bearing in the third state, wherein a spacing distance from the third part to the first axis is larger than the spacing distance from the second part to the first axis.

5. The apparatus of claim 2, wherein the body further comprises:
a first elastic member connecting the body member and the sliding member, and
wherein the bearing is moved closer to the cam by the sliding member as the sliding member is elastically pulled closer to the cam by the first elastic member to press the cam.

6. The apparatus of claim 2, wherein a slotted first guide hole extending along leftward/rightward directions is formed in the sliding member, and
wherein the body further comprises:
a first guide member configured to be inserted into the first guide hole, and configured to guide movement of the sliding member in the leftward/rightward directions.

7. The apparatus of claim 3, wherein the body further comprises:
a switch that contacts the sliding member in the first state, and spaced apart from the sliding member in the second state,
wherein the apparatus further comprises a controller electrically connected to the switch and the display, and
wherein the controller controls the display to change contents transmitted to the display based on whether the switch and the sliding member contact each other.

8. The apparatus of claim 7, wherein an opening passes through a central portion of the cam upwards and downwards, and
wherein the apparatus further comprises a wiring part passing through the opening and electrically connecting the display and the controller.

9. The apparatus of claim 3, wherein a state, in which the rotary part is maximally rotated from the first state along the first direction, is defined as a third state,
the body further comprising:
a through member configured to pass through a central portion of the bearing, and extending upwards and downwards,
wherein the rotary part comprises:
an insertion recess opening downwards, into which an upper end of the through member is inserted, and having an arcuate shape, and
wherein the through member is located at an end of the insertion recess in the first direction in the first state, and is located at an end of the insertion recess, in an opposite direction to the first direction in the third state.

10. The apparatus of claim 3, wherein the cam has a shape, in which a spacing distance from an area, in which the bearing and the cam contact each other, to the first axis decreases as the cam goes from the first state to the second state.

11. The apparatus of claim 1, wherein the body comprises:
a stopping member connected to the pressing part, and configured to be moved in an opposite direction to a movement direction of the pressing part,
wherein a state, in which the rotary part is constrained with respect to the body, is defined as a first state and a state, in which the rotary part is rotated from the first state along the first direction, is defined as a second state,
wherein a stopping recess, into which the stopping member is inserted in the first state, is formed in the rotary part.

12. The apparatus of claim 11, wherein when the pressing part is pressed toward a second direction, the stopping member is moved in an opposite direction to the second direction to deviate from the stopping recess.

13. The apparatus of claim 12, wherein the body further comprises:
a rotary member configured to be rotatable about a second axis, and connected to the pressing part and the stopping member, and
wherein the second axis is disposed between the pressing part and the stopping member.

14. The apparatus of claim 12, wherein the body further comprises:
a second elastic member configured to press the pressing part in an opposite direction to the second direction.

15. The apparatus of claim 12, wherein the body further comprises:
a third elastic member configured to press the stopping member in the second direction.

16. The apparatus of claim 11, wherein a slotted second guide hole extending along leftward/rightward directions is formed in the pressing part, and
wherein the body further comprises:
a second guide member configured to be inserted into the second guide hole, and configured to guide movement of the pressing part in the leftward/rightward directions.

17. The apparatus of claim 11, wherein a slotted third guide hole extending along leftward/rightward directions is formed in the stopping member, and
wherein the body further comprises:
a third guide member configured to be inserted into the third guide hole, and configured to guide movement of the stopping member in the leftward/rightward directions.

18. The apparatus of claim 12, wherein the rotary part further comprises:
an inclined surface member located on a side of the stopping recess and having an inclined surface to contact the stopping member when the inclined surface member returns from the second state to the first state so as to move the stopping member in an opposite direction to the second direction.

19. A walking assistance apparatus comprising:
a leg mounted part configured to be mounted on a leg of a user to assist waling of the user;
a waist mounted part provided on an upper side of the leg mounted part and configured to be mounted on a waist of the user; and
a display assembly configured to be coupled to a front side of the waist mounted part,
wherein the display assembly comprises:
a body configured to be coupled to the front side of the waist mounted part, and
a rotary part coupled to the body to be rotatable;
a display coupled to an upper side of the rotary part; and
a pressing part coupled to a side surface of the body, and configured to, when pressed, allow rotation of the rotary part,
wherein the rotary part was constrained prior to the pressing of the pressing part.
